(19) United States
(12) Patent Application Publication
(10) Pub. No.: US 2004/0230648 A1
(43) Pub. Date: Nov. 18, 2004

(54) System and method to provide maximum access to remotely hosted content in an environment with limited storage capacity

(76) Inventors: Jin Teik Teh, Los Altos, CA (US); Ling Wang, Union City, CA (US)

Correspondence Address: Jason Z. Lin, Supreme Patent Services, Post Office Box 2339, Saratoga, CA, 95070-0339, US

(21) Appl. No.: 10/440,393

(22) Filed: May 15, 2003

(51) Int. Cl. G06F 15/16

(52) U.S. Cl. 709/203

(57) ABSTRACT

The present invention is a system and a method that manages data (e.g. a file, e-book or comic) on a client, such as handheld computing device, phone or personal data assistant, over a communications link. The method includes transmitting portions of the data, which is in the form of pages, upon receipt of a signal from a client. The pages that are received by the client are stored on the client. As pages are viewed, the client requests subsequent pages to be transmitted to the client. Previously viewed pages are removed, when no longer needed, from the client to save storage space.

### FIELD OF THE INVENTION

This invention relates to data management, and more particularly to data managements on clients with limited storage capabilities in a wireless data delivery system.

### BACKGROUND OF THE INVENTION

FIG. 1 shows a wireless data delivery software system that the present invention is applicable. The system 101 comprises a platform client 102, and a platform server 103. The platform client 102 is responsible for interfacing with various clients, such as a mobile phone 110, a PDA 111, or a notebook computer 112; and the platform server 103 provides interface to various application servers 121. When a wireless client 110, 111, 112 requests for a service from an application, a request message is sent from the client to application server 121. The platform client 102, upon receiving the request message, will relay the request to the platform server 103, then forwarded to targeted application server 121, where the request is processed, and a result message is sent back to the requesting client 110, 111, 112.

Clients in a wireless data delivery system, such as phones110, personal data assistants 111, and other handheld computing devices 112, usually have limited a storage capacity. When users wish to access a larger amount of data, they are usually required to download or retrieve the entire data set from a remote application server 121. However, the limited storage capacity in these wireless devices imposes sever constrains on the number of the files that can be stored and accessed locally at any given moment.

### SUMMARY OF THE INVENTION

The present invention is a system that delivers content in separate portions so that the content can fit into limited capability devices. The system includes a database containing a plurality of content such as e-Books, e-Comics, news, stock quotes, phone books, horoscope or any electronic document that can be delivered to the client devices at the requests of a client. The present invention also provides a method to manage memory and resources on the client by removing applications and application files when memory or storage runs low on the client.

The present invention manages contents on a client, such as handheld computing device, phone or personal data assistant, over a communications link. The method includes transmitting portions of the data, which is in the form of pages, upon receipt of a signal from a client. The pages that are received by the client are stored on the client. As pages are viewed, the client requests subsequent pages to be transmitted to the client. Previously viewed pages are removed, when no longer needed, from the client to save storage space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the present invention of a system having a plurality of client devices and application servers.

FIG. 2 shows the same system in FIG. 1 at database level.

### DETAILED DESCRIPTION OF THE INVENTION

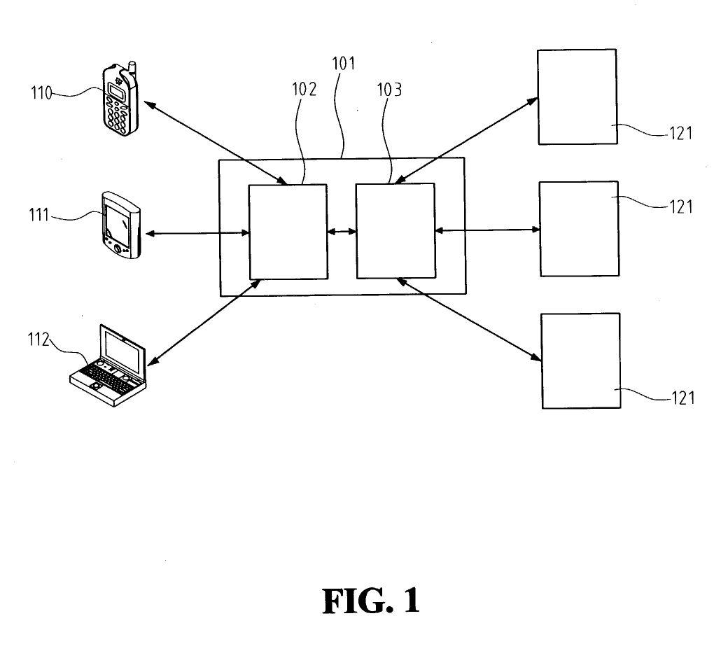

Referring to FIG. 1, the platform server 103 maintains a list of applications and data that a user owns on a device. The platform client 102 contains a partial view into the list of applications and data that is stored on the platform server. At any given moment in time, the platform client 102 has a sub-set of the applications and data stored on the platform server 103. However, the platform client 102 has the list of applications and the list of each user's applications that are stored in the platform server 103.

When a user accesses an application, the client device generates a request containing a data identifier and a page range, and sends it to the platform client. The data identifier indicates the requested data or application. The platform client 102, upon receiving the request, determines if the application is already on the platform client 102 by consulting the data identifier and the page range. If it is, it loads the application. If the application is not on the client, the platform client 102 retrieves the application information from the platform server 103. If there is insufficient storage capacity on the client, existing applications are removed using a suitable algorithm. Data belonging to applications that are removed are first synchronized to the platform server 103, and then removed with the application to save storage space. Finally, the platform client 102 retrieves the application along with its associated data and loads it for the user to use. The application information retrieved from the platform server 102 includes the size of the application and associated data. A client must also maintain a database for storing the pages of data retrieved, as well as an interface for accepting input from and displaying to the user the data identifier and page range when generating a request.

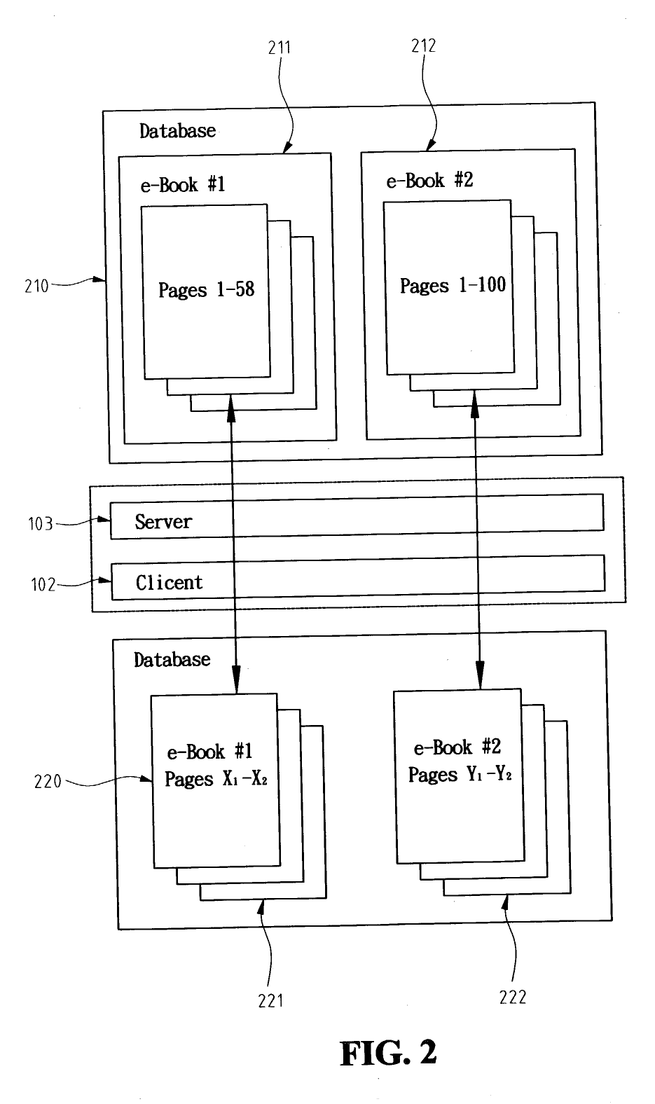

FIG. 2 shows the same system in FIG. 1 at database level. A database 210, containing a plurality of content such as e-books, e-comics, news, stock quotes, phone books, horoscope or any electronic document that can be delivered to the client devices at the requests of a client, is hosted at application servers. In FIG. 2, the example shows two e-books 211, 212 are stored at said database 210. A database 220, containing a sub-set of contents, is stored at said wireless devices. In FIG. 2, the example shows contents 221, 222, which is a subset of e-books 211 and 212 being stored locally.

When a user initially requests an e-book from the application server 121, the e-book is delivered in pages. The present embodiment defines a set of pages to contain a fixed number of pages, for example, 10 pages. The first set of pages is delivered to the user. Included with the first set is the title page, the table of contents and additional character or story information. When the user has read past a certain threshold, the next set of pages is retrieved. For example, this threshold could be set as 4 pages from the end of the set. When the threshold is reached, the next set of pages is then retrieved. At any given time, a maximum number of sets, for example, 3 sets, of pages can be on the platform client 102 for any given e-Book. In FIG. 2, the example shows that the e-book 221 currently contains 3 sets from the complete e-book 211, and the e-book 222 contains 3 sets from the complete e-book 212. A set of pages in e-book 221 is made of X2-X1 pages, and a set of pages in e-book 222 is made of Y2-Y1 pages.

When the next set of pages is to be retrieved, the previous set of pages before the current set, is removed to make room for the next set. The title page, table of contents and additional character or story information are not removed. Using this method, the number of pages and the amount of storage is restricted. Hence, increasing the number of e-books that are available for reading on the platform client 102.

While we have shown and described the embodiment in accordance with the present invention, it should be clear to those skilled in the art that further embodiments may be made without departing from the scope of the present invention.

What is claimed is:

1. In a wireless content delivery system serving a plurality of types of wireless devices and a plurality of application servers, a method for maximizing contents delivered from a remote database hosted on said application servers to said wireless devices with limited storage capacity, said method comprising:
determining a data identifier and a page range of requested data;
interpreting said data identifier and said page range;
retrieving the next range of pages of said data;
removing pages of data on said wireless devices;
updating information of said data stored locally.

2. A method claimed as in claim 1, wherein said activity of removing pages of data on said wireless devices, further comprising:
determining amount of data storage available on said client;
determining amount of data currently stored on said client;
determining amount of data requested to be retrieved from said server;
determining the range of pages of data that the user would not need for the near future;
removing sufficient amounts data from said client to be able to store said data requested from said server.

3. A wireless content delivery system comprising:
a plurality of types of wireless devices;
a plurality of application servers, forming a server database for storing a plurality of data;
a wireless transmission for communicating between the said server database and said wireless device; and
a method for maximizing contents delivered from a remote database hosted on said application servers to said wireless devices with limited storage capacity.

4. A system claimed as in claim 3, wherein said wireless device is a phone.

5. A system claimed as in claim 3, wherein said wireless device is a personal digital assistant.

6. A system claimed as in claim 3, wherein said wireless device is a handheld computing device.

7. A system claimed as in claim3, wherein wireless device is a portable computer.

8. A system claimed as in claim 3, wherein said data is a file.

9. A system claimed as in claim 3, wherein said data is an e-book.

10. A system claimed as in claim 3, wherein said data is an e-comics.

11. A system claimed as in claim 3, wherein said data is an electronic documents

12. A system claimed as in claim 3, wherein the transmission comprises a telephone link.

13. A system claimed as in claim 3, wherein the transmission comprises a radio-frequency link.

14. A system claimed as in claim 3, wherein the transmission comprises an internet link.

15. A system claimed as in claim 3, wherein the transmission comprises a satellite link.

16. A system claimed as in claim 3, wherein the transmission comprises an infra-red link.

17. A system claimed as in claim 3, wherein the transmission comprises a cellular communications link.
